(19) United States
(12) Patent Application Publication
(10) Pub. No.: US 2010/0181194 A1
(43) Pub. Date: Jul. 22, 2010

(54) MICROELECTRONIC DEVICE WITH POWER LINES AND SIGNAL LINES

(75) Inventors: David Andrew Fish, Hayward Heath (GB); Mark Thomas Johnson, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/376,612

(22) PCT Filed: Jul. 10, 2007
(86) PCT No.: PCT/IB07/52748

§ 371 Date: Feb. 6, 2009

(30) Foreign Application Priority Data
Aug. 9, 2006 (EP) 06118659.9

(51) Int. Cl. G01N 27/26; H02G 5/02; B23P 17/04

(52) U.S. Cl. 204/450; 307/147; 29/592.1

(57) ABSTRACT

The invention relates to a microelectronic device for manipulating a sample, the device comprising an array of actuator units (AU) and an array of sensitive units (SU). The actuator units (AU) may particularly exert dielectrophoretic forces on a sample (1) in an adjacent sample chamber, and the sensitive units (SU) optionally measure properties of said sample. Furthermore, the actuator units (AU) are linked to a set of power lines (PL) and the sensitive units (SU) are linked to a set of signal lines (SL), wherein the routing of these lines is such that the effects of parasitic couplings are minimized for a given set of alternating electrical power signals on the power lines. The power lines (PL) may particularly be supplied with alternating electrical signals that are identical besides a phase shift. Optionally, the couplings between the power lines and the signal lines are adapted to provide a maximal compensation of cross-talk effects.

The invention relates to a microelectronic device for manipulating a sample, comprising an array of actuator units and sensitive units that are connected to power lines and signal lines, respectively. Moreover, it relates to the use and a method for the fabrication of such a microelectronic device.

From the WO 00/69565 A1 a microelectronic device is known which comprises an array of selectively addressable electrodes that are used for manipulating particles by dielectrophoretic forces. The device may further comprise an array of sensor units for controlling the displacement of said particles.

In microelectronic devices of the aforementioned kind, a set of lines is needed for connecting the cells of the arrays to the outside, wherein a parasitic (capacitive and/or inductive) cross-talk between these lines is practically unavoidable. Such a cross-talk poses however a severe problem if some of the lines carry sensitive signals, e.g. weak measurement signals, while others carry relatively strong power signals.

Based on this situation it was an object of the present invention to provide means for improving in a microelectronic device the access to the units of an array. In particular, it is desired to reduce negative effect of cross-talk between lines contacting said units.

This objective is achieved by a microelectronic device according to claim 1, a method according to claim 10, and a use according to claim 12. Preferred embodiments are disclosed in the dependent claims.

The microelectronic device according to the present invention is intended for the manipulation of a sample, particularly a liquid or gaseous chemical substance like a biological body fluid which may contain particles. The term “manipulation” shall denote any interaction with said sample, for example measuring characteristic quantities of the sample, investigating its properties, processing it mechanically or chemically or the like. The sample will usually be provided in a sample chamber, e.g. an empty cavity or a cavity filled with some substance like a gel that may absorb a sample substance, wherein the cavity may be open, closed, or connected to other cavities by fluid connection channels. The microelectronic device comprises the following components:
a) An array of actuator units, wherein the term “actuator unit” shall denote in the most general sense a component that can controllably generate certain effects, for example exert forces on a sample or sense properties of a sample. While each actuator unit of the array may in principle be different from the other ones, it is preferred that all actuator units of the array are (substantially) of the same design. Moreover, the term “array” shall denote in the context of the present application any arbitrary three-dimensional arrangement of a plurality of units. Typically such an array will be two-dimensional and preferably planar, and its units will optionally be arranged in a regular pattern, for example a grid or matrix pattern.
b) A set of power lines, wherein each actuator unit is coupled to at least one of said power lines. The term “power line” shall indicate that the electrical signals carried by these lines will typically have a relatively large power, e.g. for transporting energy to the actuator units; the term shall however not limit the design or use of these lines in any way. In general, components, e.g. drivers, located outside the array of actuator units are given access to the actuator units via the power lines.
c) An array of sensitive units, wherein the term “sensitive unit” shall again denote in the most general sense a component serving some dedicated function, for example the generation of measurement signals indicating some property of a nearby sample. Without restriction of generality, the adjective “sensitive” is intended to indicate that in most cases the electrical signals provided to or from these sensitive units are particularly prone to corruption by parasitic effects.
d) A set of signal lines, wherein each sensitive unit is coupled to at least one signal line. Again, the general purpose of the signal lines is to provide external components (e.g. signal processing circuits for read-out and processing of measurement signals) access to the sensitive units. Moreover, the routing of the signal lines and the power lines shall be such that the effects of parasitic couplings between the power lines and the signal lines are minimized for a given set of alternating electrical power signals on the power lines. The term routing in this sense means the way or route the signal lines and the power lines take along the substrate they reside on. The parasitic couplings may particularly be capacitive and/or inductive couplings that are undesired but unavoidable side-effects of placing the signal and power lines together in the same device. While the parasitic couplings can in general not be avoided, their negative effects can however be reduced (and ideally be cancelled) by a suitable routing of signal lines and power lines. As the effect of the parasitic couplings will typically depend on the applied electrical signals, the minimization is specifically done for a set of alternating power signals that shall be applied to the power lines during the application of the microelectronic device.

The described microelectronic device has the advantage to provide a communication with the sensitive units via the signal lines that is minimally corrupted by interferences from the power lines (and vice versa). This is of particular benefit in sensor devices that comprise actuator units for manipulating a sample and sensitive sensor units for measuring some property of the sample, wherein the relatively strong power supply signals to the actuator units usually severely corrupt the weak sensor signals.

According to a preferred embodiment of the microelectronic device, at least one of its power lines has at least one intersection with at least one of the signal lines. Intersections between lines are a usual feature of microelectronic devices with arrays of single units, and they are unfortunately also a main source of parasitic couplings between said lines. In the context of the present invention, such intersections can however deliberately be designed to achieve a minimization of the coupling effects.

The power lines and the signal lines may particularly be arranged perpendicular with respect to each other. Thus a matrix arrangement can be realized in which external circuits connected to the power lines and the signal lines, respectively, can be located at different borders of a microchip. As in this case each power line crosses each signal line and vice versa, leading to a correspondingly high level of cross-talk, the proposed minimization of parasitic coupling effects is of particular benefit for such a matrix design.

In a further development of the aforementioned embodiments, the mentioned intersection is designed such that a particular parasitic coupling strength between the power line and the signal line is achieved. The power line and/or the signal line may for example be enlarged or thinned at the intersection, which especially affects the capacitive coupling between the lines. The deliberate design of the parasitic coupling strength (which may also include a seemingly paradox artificial increase of the parasitic coupling strength) can help to mutually compensate the interferences from different power lines to the signal lines.

In a further a development of the invention, the microelectronic device comprises at least one trimming line that (i) crosses at least one signal line, (ii) is not connected to an actuator unit (and is therefore different from a power line), and (iii) can be provided with an alternating electrical trimming signal. The trimming signal may particularly be one from the given set of alternating electrical power signals which are intended for the power lines. This is for example the case if the trimming line is connected in parallel to one of the power lines. Moreover, the trimming line preferably crosses all signal lines at least one times, and it is favorably located at a border of the array of actuator/sensitive units. The (typically only) purpose of the trimming line is to deliberately introduce an “artificial” parasitic coupling that helps to compensate the effect of “normal” parasitic couplings originating from the usual power lines.

In a further a development of the aforementioned embodiment, the trimming line comprises a switch or a fusing section that provides a means for selectively interrupting the trimming line if desired. The fusing section may simply be a region of the trimming line that is accessible for external destruction, e.g. by laser cutting. Interruption of the trimming line will stop its parasitic coupling to the associated signal line(s) and therefore provides a control variable for the minimization of parasitic coupling effects.

In general, the electrical power signals that are possible as intended signals on the power lines underlie no restriction besides being alternating (i.e. AC). Preferably, the given set of alternating electrical power signals comprises however a subset of power signals that differ only by phase shifts and/or by a scaling factor from each other. For such signals it is often possible to superimpose them (possibly after a rescaling) in such a way that they—at least approximately—compensate. Preferably, the whole given set of alternating electrical power signal consists of one or more of the mentioned subsets.

The actuator units may comprise an electrode for generating an electrical field that has for example some desired effect on a nearby sample. The electrical field may for instance be an alternating field that is suited for generating a dielectrophoretic force on objects near the actuator unit.

At least one of the sensitive units may optionally comprise a sensor element, preferably an optical, magnetic or electrical sensor element for sensing properties of a nearby sample and for generating a sensor signal on the associated signal line. A microelectronic device with magnetic sensor elements is for example described in the WO 2005/010543 A1 and WO 2005/010542 A2. Said device is used as a microfluidic biosensor for the detection of biological molecules labeled with magnetic beads. It is provided with an array of sensor units comprising wires for the generation of a magnetic field and Giant Magneto Resistance devices (GMRs) for the detection of stray fields generated by magnetized beads.

The invention further relates to a method for manufacturing a microelectronic device, particularly a microelectronic device of the kind described above, wherein said device comprises the following components:
a) an array of actuator units;
b) a set of power lines, wherein each actuator unit is coupled to at least one power line;
c) an array of sensitive units;
d) a set of signal lines, wherein each sensitive unit is coupled to at least one signal line.

The method further comprises the step of routing the signal lines and the power lines such that the effect of parasitic couplings between power lines and signal lines is minimized for a given set of alternating electrical power signals on the power lines.

The method comprises in general form the steps that can be executed with a microelectronic device of the kind described above. Therefore, reference is made to the preceding description for more information on the details, advantages and improvements of that method.

According to one preferred embodiment of the method, at least one trimming line is provided that (i) crosses at least one signal line, (ii) is not connected to an actuator unit, (iii) can be provided with an alternating electrical power signal, and (iv) comprises a switch or a fusing section for selectively interrupting it, wherein said trimming line is selectively interrupted if this reduces the deviation of the fabricated microelectronic device from target characteristics. The selective interruption of said line can therefore be used to compensate device-to-device variations originating from the factoring process.

The invention further relates to the use of the microelectronic devices described above for molecular diagnostics, biological sample analysis, or chemical sample analysis, food analysis, and/or forensic analysis. Molecular diagnostics may for example be accomplished with the help of magnetic beads or fluorescent particles that are directly or indirectly attached to target molecules.

These and other aspects of the invention will be apparent from and elucidated with reference to the embodiment(s) described hereinafter. These embodiments will be described by way of example with the help of the accompanying drawings in which:

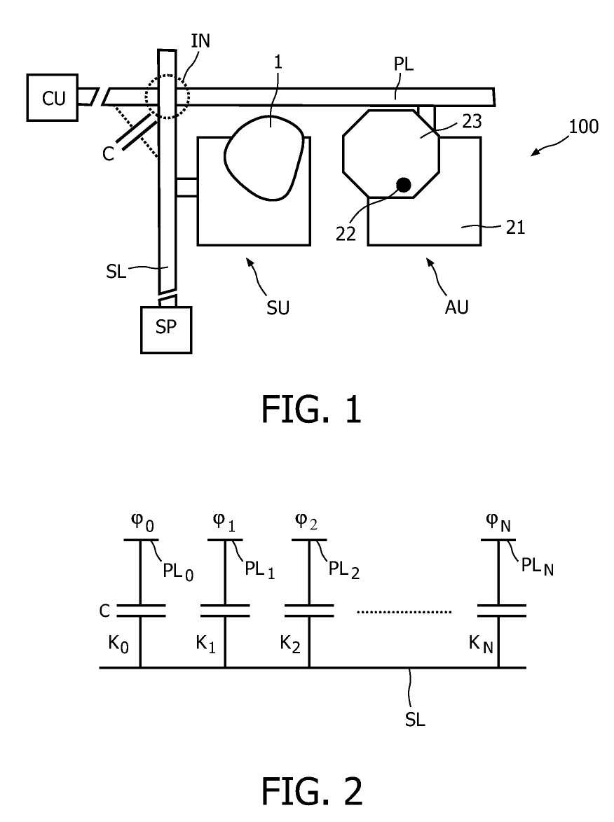

FIG. 1 shows a schematic top view of one cell of a microelectronic device according to the present invention comprising one sensitive unit and one actuator unit;

FIG. 2 shows an equivalent circuit for the parasitic capacitive couplings between a set of power lines and one signal line;

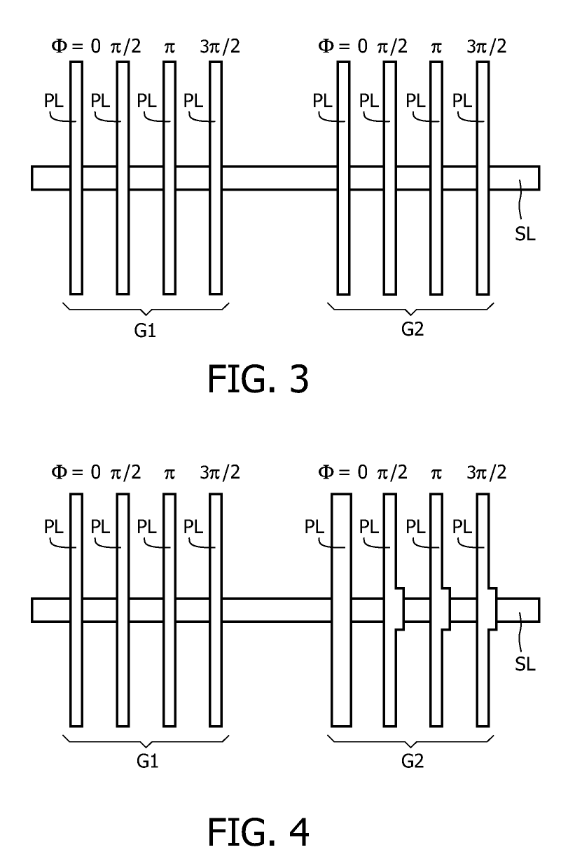

FIG. 3 shows the intersections of two groups of power lines with one signal line;

FIG. 4 shows a similar situation as FIG. 3, wherein however some of the power lines are thickened at the intersections;

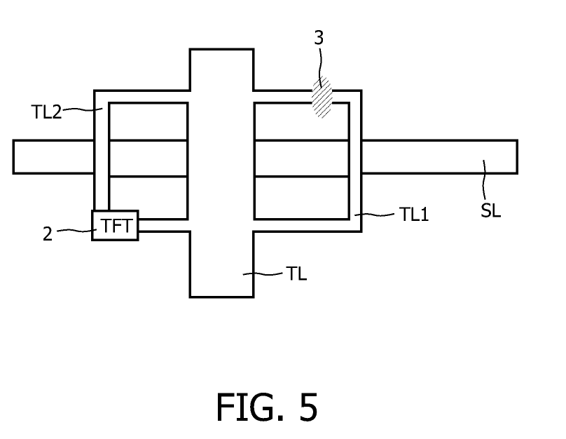

FIG. 5 shows a trimming line crossing a signal line with two additional trimming lines that can selectively be interrupted.

Like reference numbers in the Figures refer to identical or similar components.

Biochips for (bio)chemical analysis, such as molecular diagnostics, will become an important tool for a variety of medical, forensic and food applications. In general, biochips comprise a biosensor in most of which target molecules (e.g. proteins, DNA) are immobilized on biochemical surfaces with capturing molecules and subsequently detected using for instance optical, magnetic or electrical detection schemes. Examples of magnetic biochips are described in the WO 2003/054566, WO 2003/054523, WO 2005/010542 A2, WO 2005/010543 A1, and WO 2005/038911 A1, which are incorporated into the present application by reference.

FIG. 1 shows in this respect schematically one cell 100 of a microelectronic sensor device according to the present invention, wherein said cell belongs to an array with a large number of such cells. The cell 100 comprises means for the manipulation of bio-particles 1 such as cells and molecules in fluids that are present in a sample chamber above the array, wherein said manipulation may particularly comprise the use of the dielectrophoretic (DEP) effect (cf. H. Morgan, N. Green: “AC Electrokinetics: Colloids and Nanoparticles”, Research Studies Press, 2003). To provide a fully functional system, active components such as transistors (silicon substrates) or Thin Film Transistors (TFTs) on glass substrates (e.g. Low Temperature Poly-Silicon LTPS) will be required to actuate the required AC fields at a desired location. To provide movement of the bio-particles 1 to specific locations, sensing will also be required, for example using sensors such as photo-transistors or photo-diodes. The location of bio-particles can then be changed via the feedback of current positional information from the sensors to the actuators that control the AC fields applied to the fluids in which the bio-particles are suspended (cf. N. Manaresi, A. Romani, G. Medoro, L. Alyomare, A. Leonardi, M. Tartagni, R. Guerrieri: “A CMOS chip for individual cell manipulation and detection”, IEEE Journal of Solid State Circuits, p. 2297 (2003)). While a number of the actuator electrodes controls the particle position, light (e.g. from an external source) can be sensed and this will change as a bio-particle moves over the sensor unit.

To provide the aforementioned functionalities, the cell 100 comprises a sensitive unit, in the following called sensor unit SU, that is coupled to a signal line SL, wherein the signal line runs vertically across the array and is connected to a signal processing circuit SP located at the lower border of the array. Further sensor units of the same vertical column are typically connected to the same signal line SL, wherein they can selectively be addressed by an appropriate matrix addressing circuitry (not shown).

Moreover, an actuator unit AU with an actuator site 21 is located adjacent to the sensor unit SU, said actuator unit comprising a drive electrode 23 connected by a via 22 to an AC power line PL running horizontally across the array. At the border of the array, the power line PL is connected to an external control unit CU. Again, all other actuator units lying in the same row are typically connected to the same power line PL.

The described arrays of sensor units SU and actuator units AU may for example have the layout of metal lines on a silicon integrated circuit (IC) or a TFT based glass technology such as LTPS. The drive electrode 23 will be in the highest metal layer of the stack, while the metal layers of the signal line SL and the power line PL will be lower metal layers.

In a microelectronic device like that of FIG. 1, which comprises linear arrays or matrix arrays of sensor units SU and actuator units AU, the signals from the sensor units will have to cross power lines supplying the actuator units which will carry AC fields at high frequency. Capacitive coupling between the power lines PL and the sensor lines SL will occur at their intersections IN, and this may corrupt the sensor signal to such a degree that it becomes useless. Said parasitic capacitive coupling is indicated in FIG. 1 by a capacitor C between the power line PL and the signal line SL. In the following, a solution to the aforementioned problems will be developed based on the example of DEP systems, though it is in no way restricted to this particular application.

DEP systems typically use a number of AC fields of specific phases, e.g. 0°, 90°, 180°, 270° with constant amplitudes. The proposed method to overcome the issue of capacitive coupling will therefore use the general layout principle that any sensor line or any other signal carrying line must cross a number of power lines carrying an AC phase signal such that the total AC signal crossing that line sums to zero.

A general equivalent circuit of the parasitic capacitive coupling is shown in FIG. 2, where an arbitrary number N of power lines PL with AC phases Φᵢ couple to one signal line SL. If the signal line SL is high impedance (for instance if a photocurrent is measured), then the AC phases will modulate the signal line SL and corrupt any signal upon it. If the AC signals generated in the signal line are of the form

Vⱼ=V_{A} exp(iωt+iΦⱼ)

where V_{A} is the amplitude, ω is the angular frequency, and Φⱼ is the phase shift, then the total signal coupling from the AC phases (assuming the capacitance of each AC power line to the signal line SL is the same) is

$${V}_{S} = \frac{1}{N} {V}_{A} exp ( iω t ) {\sum }_{j = 0}^{N - 1} exp ( {iϕ}_{j} ) .$$

The summation term must be zero to compensate coupling to the signal line. Therefore the layout must be arranged such that the phases of the AC signals crossing the signal line SL are such that the summation above is zero.

A slightly less general scheme illustrates the cases that will likely to be seen in a DEP system. If the phase difference Φ between two successive phases is a constant, i.e. all phases can be represented as Φⱼ=j·Φ then the summation becomes a geometric sum and can be written as

$${\sum }_{j = 0}^{N - 1} exp ( ijϕ ) = \frac{1 - exp ( i N ϕ )}{1 - exp ( iϕ )} = 0$$

Therefore NΦ=2nπ, where n is an integer. If for example n=1, the phase difference becomes Φ=2π/N. Examples of this case are AC power lines of phases 0 and π (i.e. Φ=π and N=2, giving NΦ=2π), and the signal line SL must cross both power lines to compensate coupling. Another example are AC power lines of phases 0, π/2, π and 3π/2 (i.e. Φ=π/2 and N=4, giving NΦ=2π); again the signal line cross all four power lines to compensate coupling. If the signal line SL crosses AC power lines multiple times, then it must be ensured that the relation NΦ=2nπ is still valid, wherein n is integer. The set of phases must therefore be crossed an integer number of times. This is illustrated in FIG. 3 for the case n=2, i.e. two groups G1, G2 of power lines PL carrying all phases cross the signal line SL.

It was assumed so far that the capacitance from each AC phase to the signal line SL was the same. In reality this may not always be the case, so that the capacitive coupling from each AC phase may differ. The coupling formula will then become

$${V}_{S} = {V}_{A} exp ( iω t ) {\sum }_{j = 0}^{N - 1} {K}_{j} exp ( {iϕ}_{j} )$$

where the Kⱼ are capacitive coupling terms. The summation must again be zero to prevent coupling.

A simple layout method that takes different coupling terms into account is to thicken or thin down lines (at least at their intersections) where necessary to bring the capacitance values equal again. FIG. 4 shows an example where power lines PL of the second group G2 are thickened at their intersection with the signal line SL where necessary so that all of them have the same width when crossing the signal line.

FIG. 5 refers to a further development of the microelectronic device comprising particular trimming lines for the decoupling of signal lines from AC power lines. In this case, the microelectronic device with its signal lines and power lines is first designed and laid out in a manner most suited to its primary functionality, i.e. no attention is paid to the AC coupling problem at this stage.

After said layout is completed, the weighted sum of the AC signals that cross each sensor line SL is calculated. A set of “AC trimming lines” TL is then provided on the device. In the case of FIGS. 3 and 4, four such trimming lines with different phases 0°, 90°, 180° and 270° would for example be present. All the trimming lines cross all the signal lines, preferably at the edge of the device (e.g. between the device and the sensing measurement point or probe point if an external measurement device is used). The size of the cross-over capacitance of the signal line SL with each of the trimming lines is chosen to ensure that the weighted sum of the AC signals that cross that signal line is zero. Said size can be varied by locally altering the width of the trimming lines or the signal line or both. In all cases, the extra area required for any thickening of lines does not restrict the device functionality, as it takes place at the border of the array.

Whilst above the situation of a single set of trimming lines was considered, it is of course possible to consider also the use of either more than one set of trimming lines, or alternatively and preferably multiple cross-overs to each trimming line. FIG. 5 comprises a preferred realization of the latter case, in which parallel side-arms TL1, TL2 branch from the main trimming line TL, said side-arms TL1, TL2 comprising a thin film transistor 2 and a “fusing section” 3, respectively. The side-arms TL1, TL2 make it possible to realize a device-to-device fine tuning by carrying out a selective removal of cross-overs (by e.g. laser cutting the fusing section 3, or by electrically isolating the cross-overs with the switch 2). Such a fine tuning could account for any batch-to-batch or device-to-device variations in the manufacturing process.

In summary, the above embodiments realize a very general routing scheme for signal lines (carrying signals from a sensor or otherwise) that requires the weighted sum of the AC signals crossing that signal lines to be as small as possible, ideally zero, where the weighting is given by the coupling strengths.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A microelectronic device for manipulating a sample, comprising
a) an array of actuator units (AU);
b) a set of power lines (PL), wherein each actuator unit (AU) is coupled to at least one power line;
c) an array of sensitive units (SU);
d) a set of signal lines (SL), wherein each sensitive unit (SU) is coupled to at least one signal line and wherein the routing of signal lines (SL) and power lines (PL) is such that the effects of parasitic couplings between the power lines and the signal lines are minimized for a given set of alternating electrical power signals on the power lines.

2. The microelectronic device according to claim 1,
characterized in that at least one of the power lines (PL) has at least one intersection (IN) with at least one of the signal lines (SL).

3. The microelectronic device according to claim 2,
characterized in that the intersection is designed such that a predetermined parasitic coupling strength between the power line (PL) and the signal line (SL) is achieved.

4. The microelectronic device according to claim 2,
characterized in that the power line (PL) and/or the signal line (SL) is enlarged or thinned down at the intersection.

5. The microelectronic device according to claim 1,
characterized in that it comprises at least one trimming line (TL, TL1, TL2) that intersects at least one signal line (SL), is not connected to an actuator unit (AU), and can be provided with an alternating electrical trimming signal.

6. The microelectronic device according to claim 5,
characterized in that the trimming line (TL, TL1, TL2) comprises a switch (2) or a fusing section (3) for selectively interrupting it.

7. The microelectronic device according to claim 1,
characterized in that the given set of alternating electrical power signals comprises a subset of power signals that differ only by a phase shift and/or by a scaling factor.

8. The microelectronic device according to claim 1,
characterized in that the actuator units (AU) comprise an electrode (23) for generating an electrical field, particularly an alternating electrical field suited for exerting a DEP force on objects (1) near the actuator unit.

9. The microelectronic device according to claim 1,
characterized in that at least one of the sensitive units (SU) comprises a sensor element for generating a sensor signal on the signal lines (SL).

10. A method for manufacturing a microelectronic device with
a) an array of actuator units (AU);
b) a set of power lines (PL), wherein each actuator unit (AU) is coupled to at least one power line;
c) an array of sensitive units (SU);
d) a set of signal lines (SL), wherein each sensitive unit (SU) is coupled to at least one signal line;
wherein the method comprises the generation of a routing of signal lines (SL) and power lines (PL) such that the effects of parasitic couplings between the power lines and the signal lines are minimized for a given set of alternating electrical power signals on the power lines.

11. The method according to claim 10,
characterized in that at least one trimming line (TL, TL1, TL2) is provided that
crosses at least one signal line,
is not connected to an actuator units (AU),
can be provided with an alternating electrical power signal, and
comprises a switch (2) or fusing section (3) for selectively interrupting the trimming line,
wherein the trimming line (TL, TL1, TL2) is interrupted if this reduces the deviation of the manufactured microelectronic device from target characteristics.

12. Use of the microelectronic device according to claim 1 for molecular diagnostics, biological sample analysis, or chemical sample analysis.
